(19) United States
(12) Patent Application Publication
(10) Pub. No.: US 2026/0092585 A1
(43) Pub. Date: Apr. 2, 2026

(54) GENERAL-PURPOSE ENGINE UNIT

(71) Applicant: HONDA MOTOR CO., LTD., Tokyo (JP)

(72) Inventors: Hiroaki KOJIMA, Tokyo (JP); Tetsuya ARAI, Tokyo (JP); Naohiro IKEDA, Tokyo (JP); Keita INAMURA, Tokyo (JP)

(21) Appl. No.: 19/344,417

(22) Filed: Sep. 29, 2025

(30) Foreign Application Priority Data
Sep. 30, 2024 (JP) 2024-171554

(51) Int. Cl. F02M 35/10; F02M 25/08; F02M 35/02

(52) U.S. Cl. CPC F02M 35/10242; F02M 25/0872; F02M 25/089; F02M 35/0201

(57) ABSTRACT

To provide a general-purpose engine unit that allows a catch tank for temporarily storing fuel to function well. In a general-purpose engine unit (1) configured by arranging a fuel tank (2) and an air cleaner box (10) in a horizontal direction above an engine (E), the unit (1) includes a catch tank (50) disposed in proximity to the air cleaner box (10) and configured to store evaporated fuel generated inside the fuel tank (2), and a fuel tube (6) configured to send the evaporated fuel from the fuel tank (2) to the catch tank (50). The catch tank (50) is provided at a position above the engine (E) and between the fuel tank (2) and the air cleaner box (10).

This application is based on and claims the benefit of priority from Japanese Patent Application No. 2024-171554, filed on 30 September 2024, the content of which is incorporated herein by reference.

### BACKGROUND OF THE INVENTION

### Field of the Invention

The present invention relates to a general-purpose engine unit, and particularly, to a general-purpose engine unit including a catch tank for temporarily storing evaporated fuel generated inside a fuel tank.

### Related Art

Conventionally, there has been known a general-purpose engine unit in which an engine, a fuel tank, and an air cleaner box are integrally formed and which is used as a power source of a work machine or the like.

Japanese Unexamined Patent Application, Publication No. 2008-208789 discloses a general-purpose engine unit including a canister for temporarily storing condensed evaporated fuel in order to send the evaporated fuel generated inside a fuel tank to an engine via an air cleaner box.

Patent Document 1: Japanese Unexamined Patent Application, Publication No. 2008-208789

### SUMMARY OF THE INVENTION

Here, a canister filled with an adsorbent that adsorbs evaporated fuel has an advantage that fuel is unlikely to leak to the outside even when the general-purpose engine unit is largely inclined, but has a problem of high cost. On the other hand, in the case of using a catch tank as a typical container for preventing leakage of fuel in place of the canister in order to reduce the cost, various design considerations are required in order to ensure proper functioning.

It is an object of the present invention to provide a general-purpose engine unit that solves the above-described problem of the conventional art and allows a catch tank for temporarily storing fuel to function well.

To achieve the object, a first aspect of the present invention is a general-purpose engine unit (1) configured by arranging a fuel tank (2) and an air cleaner box (10) in a horizontal direction above an engine (E). The general-purpose engine unit (1) includes a catch tank (50) disposed in proximity to the air cleaner box (10) and configured to store evaporated fuel generated inside the fuel tank (2), and a fuel tube (6) configured to send the evaporated fuel from the fuel tank (2) to the catch tank (50). The catch tank (50) is provided at a position above the engine (E) and between the fuel tank (2) and the air cleaner box (10).

A second aspect is that an air inlet (18) is provided at a lower part of the air cleaner box (10). The catch tank (50) is disposed along an edge (18b) of the air inlet (18).

A third aspect is that the catch tank (50) is provided with a connection (54) to which one end part of the fuel tube (6) is connected. A rib (52) extending in a direction perpendicular to an intake direction line (18a) of the air inlet (18) is provided near the connection (54). The intake direction line (18a) is disposed within a width of the rib (52) when viewed from a connecting direction of the fuel tube (6).

A fourth aspect is that at least a part of the air inlet (18) is disposed within the width of the rib (52) when viewed in the direction perpendicular to the intake direction line (18a). The rib (52) and the air inlet (18) overlap each other along the intake direction line (18a).

A fifth aspect is that the catch tank (50) is configured such that a wall part (55) disposed along the edge (18b) is thicker than another wall part.

A sixth aspect is that the catch tank (50) is directly attached to a bottom wall (17) of the air cleaner box (10).

A seventh aspect is that the catch tank (50) is configured to have a negative pressure inside during operation of the engine (E).

According to the first aspect, the length of the fuel tube can be reduced, and the fuel tube can be disposed above the engine. Thus, the fuel tube is warmed by the heat of the engine, and the evaporated fuel inside the fuel tube can be suppressed from being cooled and liquefied.

According to the second aspect, by disposing the catch tank along the edge of the air inlet of the air cleaner box, the catch tank itself can be used as a guide for efficiently guiding air to the air inlet.

According to the third aspect, the connection can be protected by the rib, and the air hitting the rib can be guided to the air inlet to enhance the air intake efficiency.

According to the fourth aspect, it is possible to enhance the effect of guiding air to the air inlet by the rib.

According to the fifth aspect, the air guided to the air inlet can suppress the evaporated fuel in the catch tank from being cooled. Additionally, by making only the part that is hit by the air guided to the air inlet thick, it is possible to increase the support strength of the connection while suppressing an increase in the weight of the catch tank.

According to the sixth aspect, it is possible to enhance the effect of guiding air to the air inlet by the catch tank.

According to the seventh aspect, the evaporated fuel discharged from the catch tank can be prevented from flowing out to the outside, and the evaporated fuel inside the catch tank can be effectively sent to the air cleaner box.

### BRIEF DESCRIPTION OF THE DRAWINGS

FIG. 1 is an elevation view of a general-purpose engine unit according to an embodiment of the present invention;

FIG. 2 is a rear view of the general-purpose engine unit;

FIG. 3 is a plan view of the general-purpose engine unit;

FIG. 4 is a left side view of the general-purpose engine unit;

FIG. 5 is an elevation view showing a state in which a cover member of an air cleaner box is removed from the general-purpose engine unit of FIG. 1;

FIG. 6 is a partially enlarged view of FIG. 1;

FIG. 7 is a cross-sectional view taken along line VII-VII of FIG. 1;

FIG. 8 is a perspective view showing a shape of a rib;

FIG. 9 is a cross-sectional view taken along line IX-IX of FIG. 7;

FIG. 10 is a perspective view showing the internal state of a catch tank when the general-purpose engine unit is overturned, with a recoil starter facing downward;

FIG. 11 is a perspective view showing the internal state of the catch tank when the general-purpose engine unit is overturned, with a cylinder head facing downward;

FIG. 12 is a perspective view showing the internal state of the catch tank when the general-purpose engine unit is overturned, with an output shaft facing downward; and

FIG. 13 is a perspective view showing the internal state of the catch tank when the general-purpose engine unit is overturned, with a control unit facing downward.

### DETAILED DESCRIPTION OF THE INVENTION

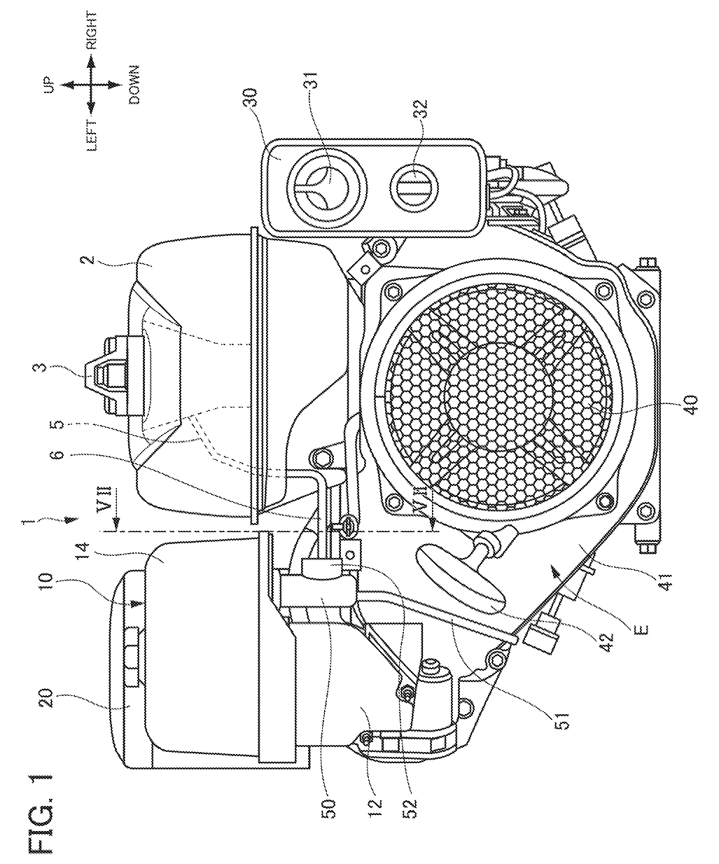

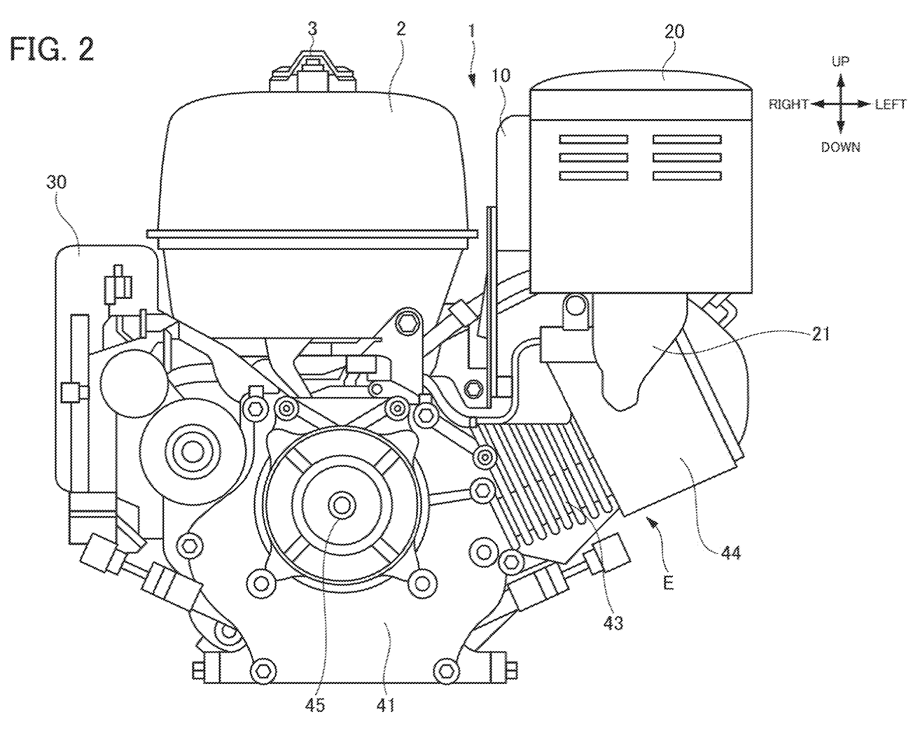

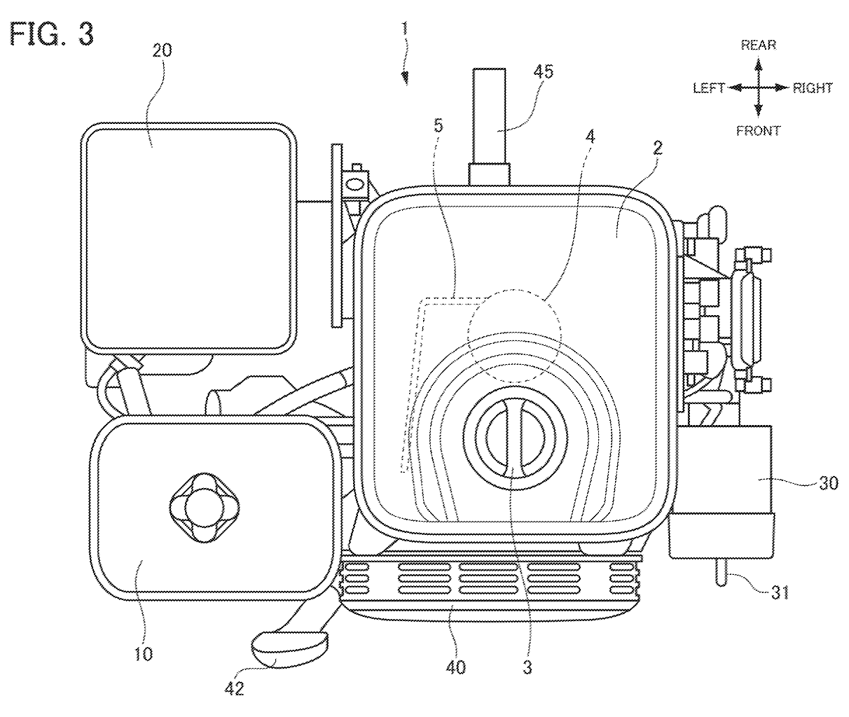

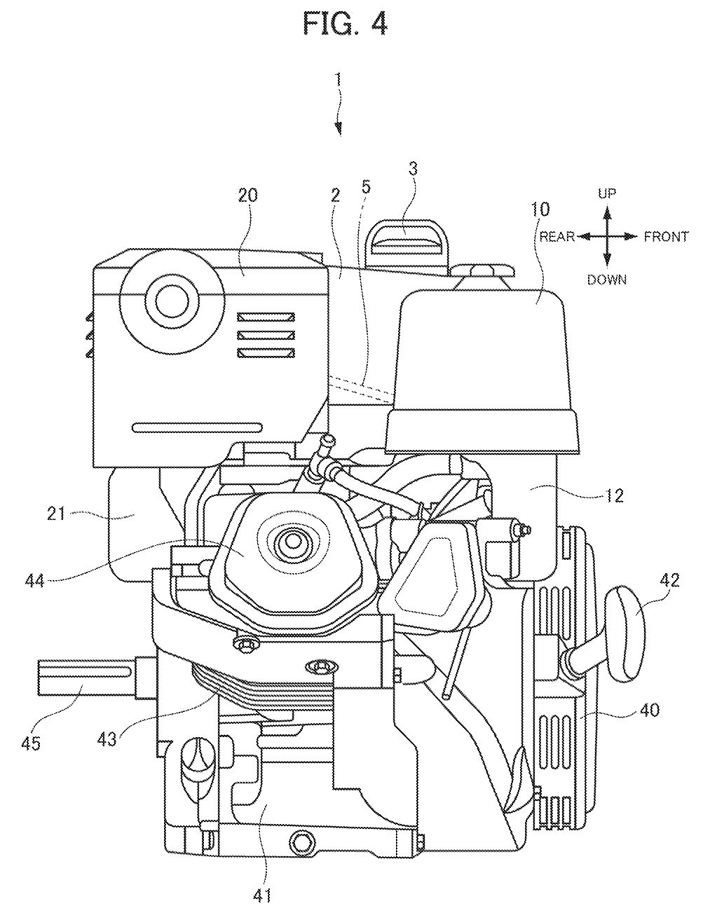

Hereinafter, a preferred embodiment of the present invention will be described in detail with reference to the drawings. FIG. 1 is an elevation view of a general-purpose engine unit 1 according to an embodiment of the present invention. FIG. 2 is a rear view of the general-purpose engine unit 1, FIG. 3 is a plan view of the general-purpose engine unit 1, and FIG. 4 is a left side view of the general-purpose engine unit 1.

The general-purpose engine unit 1 used as a power source of a work machine or the like has a configuration in which a fuel tank 2, an air cleaner box 10, and a muffler 20 are integrally arranged above an engine E which is a four-cycle single cylinder internal combustion engine. A recoil starter 40 for starting the engine E is disposed in front of a crankcase 41 of the engine E. The recoil starter 40 houses a pulley (not shown) around which a string member connected to a handle 42 is wound. When a user pulls the handle 42 upward, a crankshaft (not shown) connected to the pulley rotates.

A control unit 30 provided with operation switches 31 and 32 is disposed on the right side of the crankcase 41. A cylinder 43 in which a piston of the engine E is housed so as to be able to reciprocate is fixed to the left-side part of the crankcase 41. A cylinder head 44 that houses an intake and exhaust mechanism is fixed to the upper part of the cylinder 43. An exhaust pipe 21 connected to the lower part of the muffler 20 is connected to the rear part of the cylinder head 44. An intake pipe 12 connected to the lower part of the air cleaner box 10 is connected to the front part of the cylinder head 44. At the rear of the crankcase 41, an output shaft 45, which rotates synchronously with the crankshaft, protrudes.

A guide 4 for guiding fuel to a fuel pump is disposed below a fuel filler cap 3 of the fuel tank 2, and a charge pipe 5 for guiding the evaporated fuel generated inside the fuel tank 2 to below the fuel tank 2 is connected to the guide 4. The distal end of the charge pipe 5 is connected to a charge tube 6 as a fuel tube, and a catch tank 50 as a container for storing condensed evaporated fuel is connected to the distal end of the charge tube 6. The catch tank 50 is attached to the bottom of the air cleaner box 10, and a drain hose 51 is connected to the lower part of the catch tank 50.

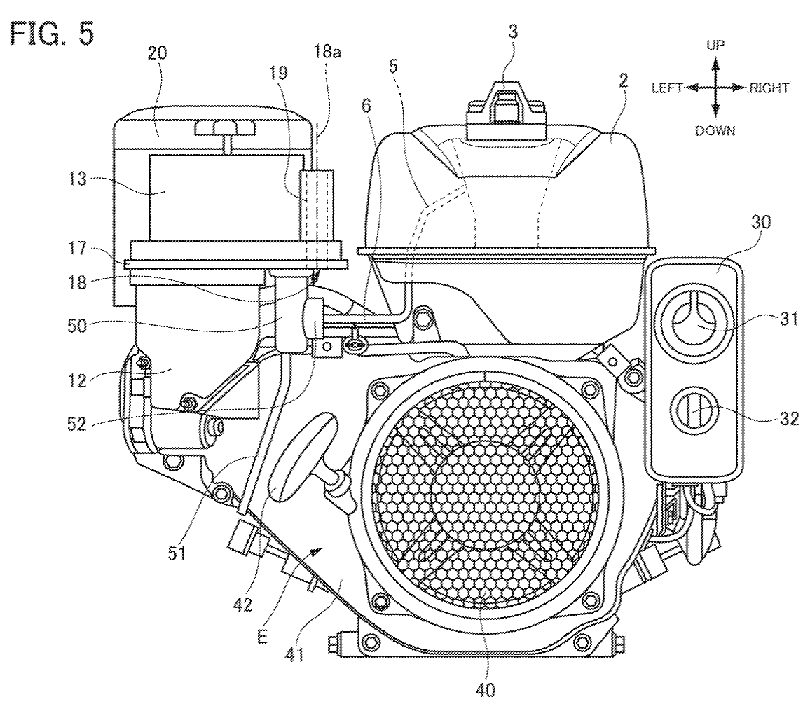

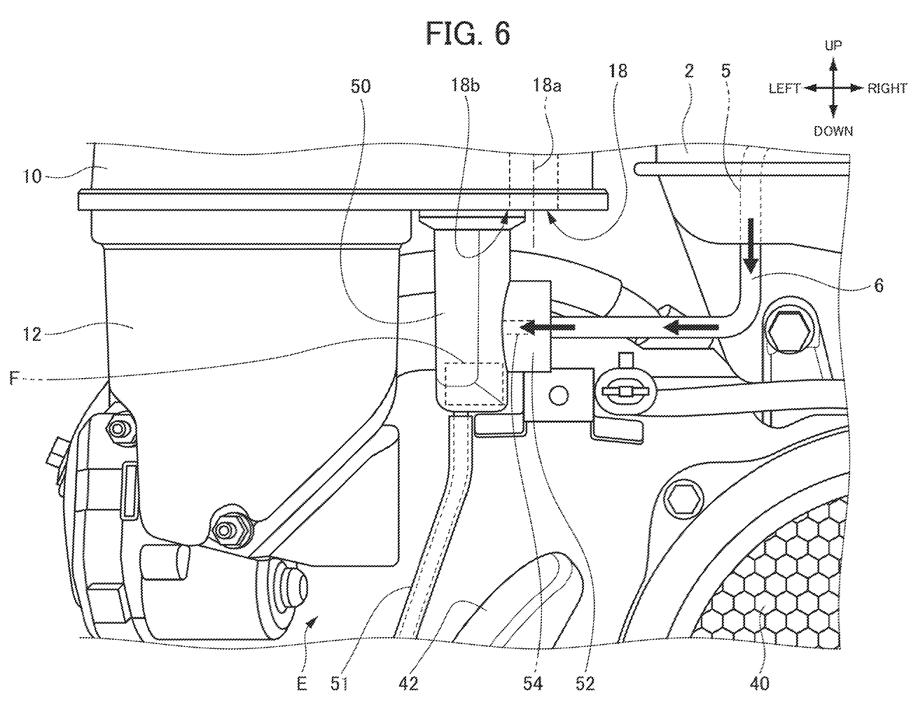

FIG. 5 is an elevation view showing a state in which a cover member 14 of the air cleaner box 10 is removed from the general-purpose engine unit 1 of FIG. 1. FIG. 6 is a partially enlarged view of FIG. 1. The same reference numerals as those described above denote the same or equivalent parts. An air element 13 is disposed above a bottom wall 17 of the air cleaner box 10. The bottom wall 17 is provided with an air inlet 18 in which an intake direction line 18a is directed in the vertical direction. A cylindrical intake guide 19 extending upward is connected to the edge of the air inlet 18.

The evaporated fuel generated inside the fuel tank 2 is guided to the catch tank 50 via the charge pipe 5 and the charge tube 6. In the general-purpose engine unit 1 according to the present embodiment, since the catch tank 50 that stores fuel F generated by condensation of the evaporated fuel is provided at a position above the engine E and between the fuel tank 2 and the air cleaner box 10, the length of the charge tube 6 can be reduced, and the charge tube 6 can be disposed above the engine E. Thus, the charge tube 6 is warmed by the heat of the engine E, and the evaporated fuel inside the charge tube 6 can be suppressed from being cooled and liquefied.

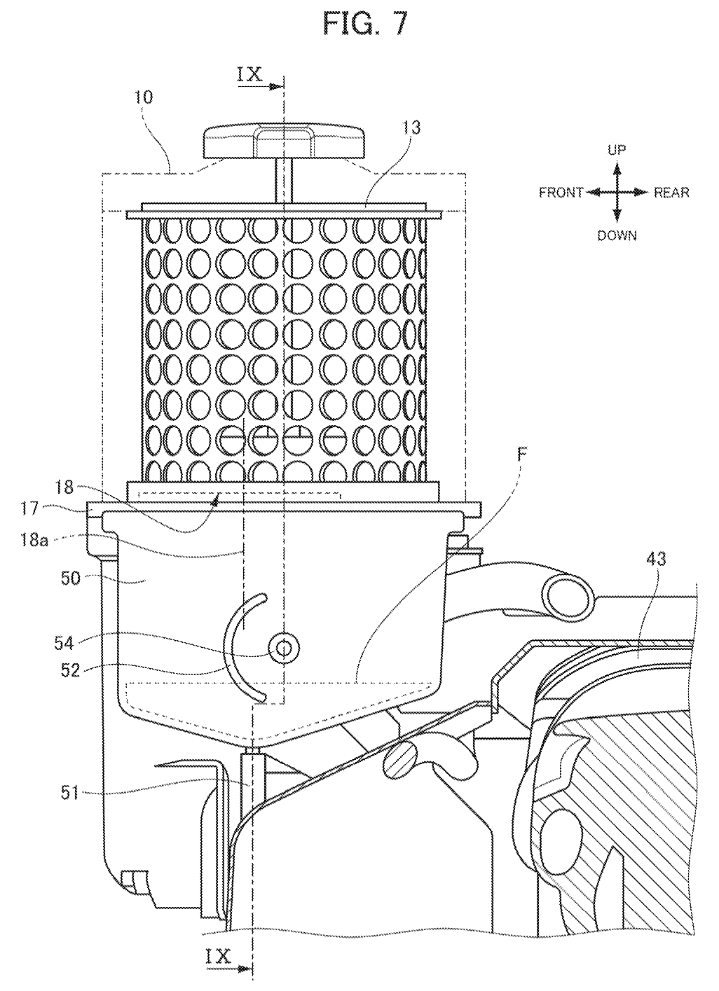

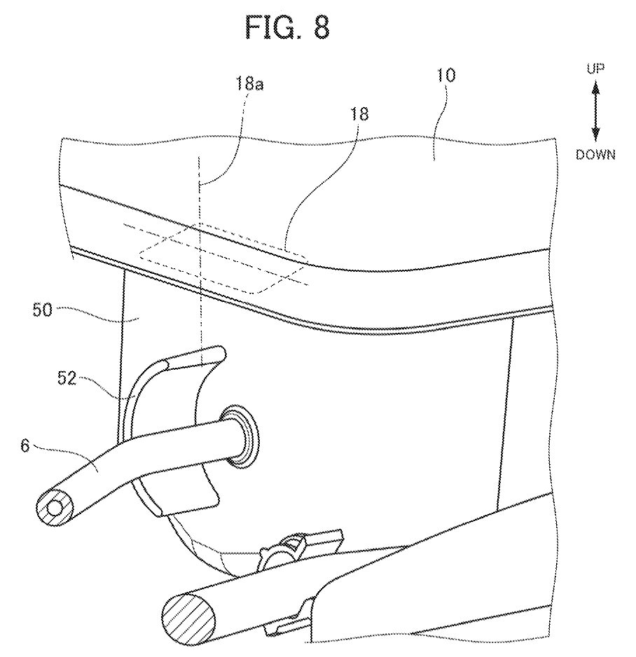

FIG. 7 is a cross-sectional view taken along line VII-VII of FIG. 1. FIG. 8 is a perspective view showing the shape of a rib 52. The same reference numerals as those described above denote the same or equivalent parts. The catch tank 50 has a shape in which the dimension in the front-rear direction is larger than the dimension in the left-right direction. A cylindrical connection 54 for connecting one end part of the charge tube 6 is provided on the right-side part of the catch tank 50. The connection 54 is disposed at a position closer to the lower side than the center of the vertical dimension of the catch tank 50.

A curved plate-shaped rib 52 is provided in front of the connection 54 so as to extend in a direction perpendicular to the intake direction line 18a of the air inlet 18. In the present embodiment, at least a part of the rib 52 is configured to overlap the air inlet 18 when viewed from the direction of the intake direction line 18a. As a result, the connection 54 can be protected by the rib 52, and the air hitting the rib 52 is guided to the air inlet 18, so that the air intake efficiency can be enhanced. At least a part of the air inlet 18 is disposed within the width of the rib 52 when viewed in the direction perpendicular to the intake direction line 18a, and the rib 52 and the air inlet 18 are configured to overlap each other along the intake direction line 18a, and the intake direction line 18a is disposed within the width of the rib 52 when viewed from the connecting direction of the fuel tube 6. Accordingly, the effect of guiding air to the air inlet 18 by the rib 52 is further enhanced.

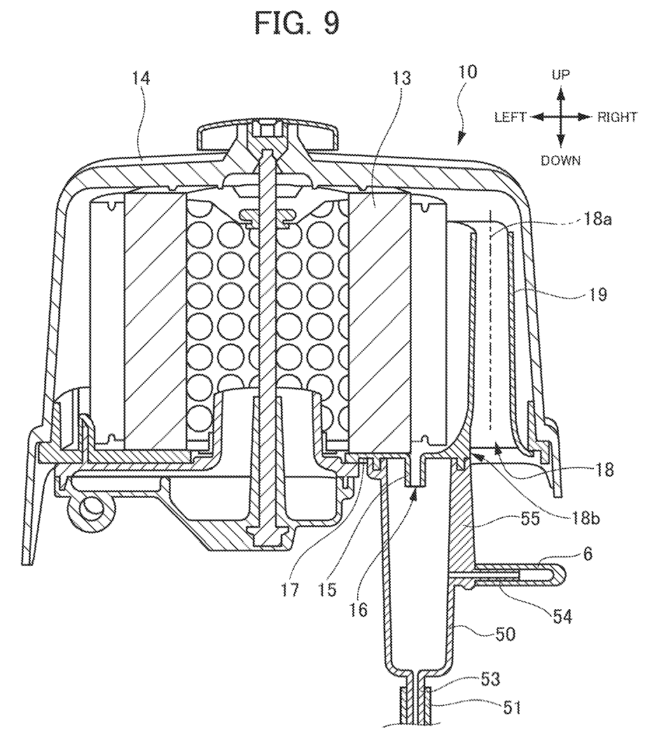

FIG. 9 is a cross-sectional view taken along line IX-IX of FIG. 7. The same reference numerals as those described above denote the same or equivalent parts. A drain pipe 53 to which a drain tube 51 is connected is provided at the lower end part of the catch tank 50. The bottom wall 17 of the air cleaner box 10 to which the catch tank 50 is attached is provided with a cylindrical outlet member 15 having an outlet hole 16 for guiding the evaporated fuel temporarily stored in the catch tank 50 into the air cleaner box 10.

In the general-purpose engine unit 1 according to the present embodiment, since the air cleaner box 10 is in communication with the catch tank 50, the catch tank 50 is configured to have a negative pressure inside during operation of the engine E. For example, it may be configured such that the pressure becomes -77.2 Pa when the engine speed is 3600 rpm, and the pressure becomes -0.1 Pa when the engine speed is 1400 rpm. Thus, the evaporated fuel in the catch tank 50 can be effectively sent to the air cleaner box 10.

The air inlet 18 of the air cleaner box 10 is formed at a position on the right side of the bottom wall 17. The catch tank 50 is directly attached to the lower part of the bottom wall 17 along an edge 18b of the air inlet 18. Thus, the catch tank 50 itself can be used as a guide for efficiently guiding air to the air inlet 18. The catch tank 50 is configured such that a wall part 55 disposed along the edge 18b of the air inlet 18 is thicker than another wall part. As a result, the air guided to the air inlet 18 can suppress the evaporated fuel stored in the catch tank 50 from being cooled. Additionally, by making only the wall part 55 against which the air guided to the air inlet 18 hits thick, it is possible to increase the support strength of the connection 54 while suppressing an increase in the weight of the catch tank 50.

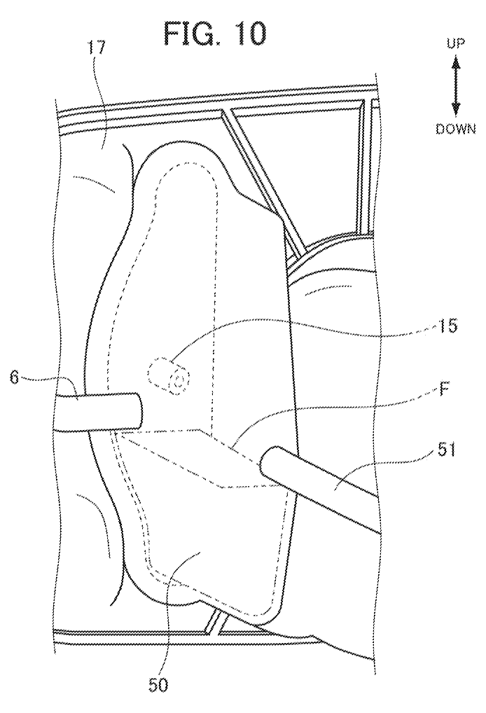

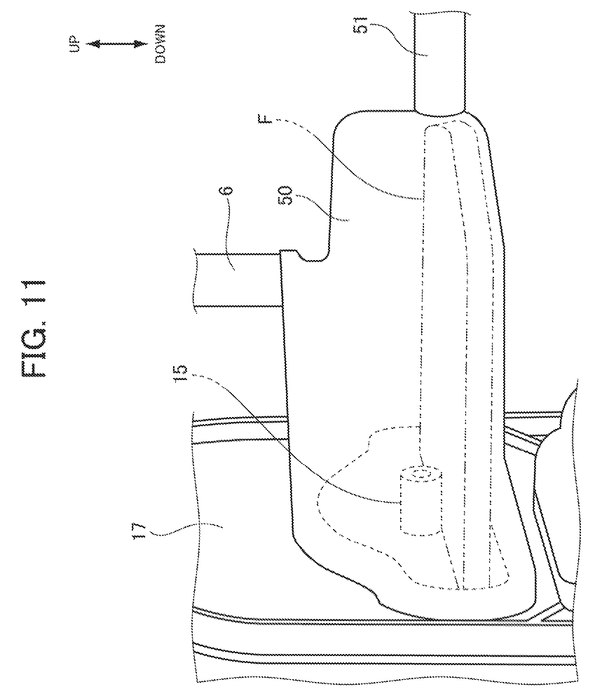

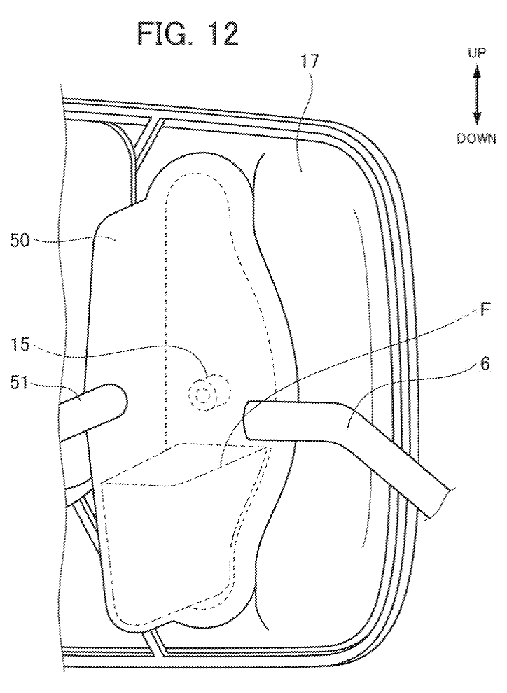

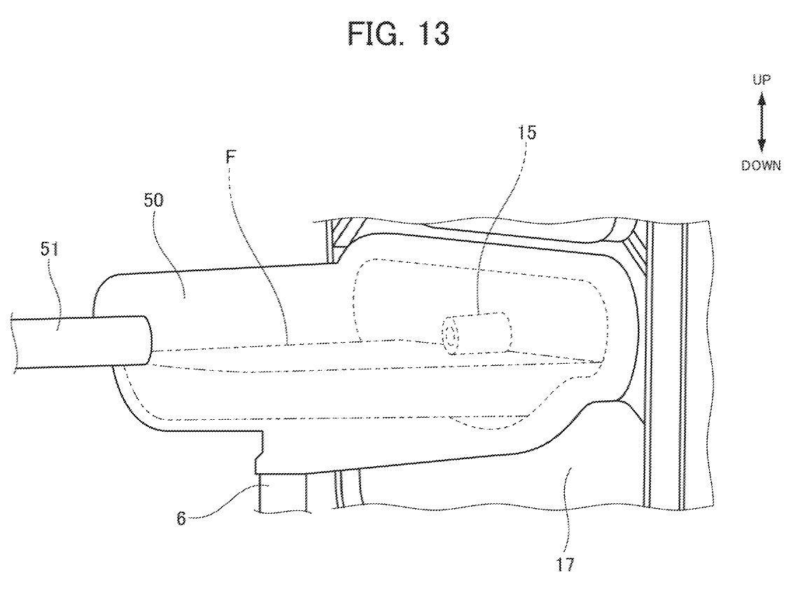

FIG. 10 is a perspective view showing the internal state of the catch tank 50 when the general-purpose engine unit 1 is overturned, with the recoil starter 40 facing downward. FIG. 11 is a perspective view showing the internal state of the catch tank 50 when the general-purpose engine unit 1 is overturned, with the cylinder head 44 facing downward, FIG. 12 is a perspective view showing the internal state of the catch tank 50 when the general-purpose engine unit 1 is overturned, with the output shaft 45 facing downward, and FIG. 13 is a perspective view showing the internal state of the catch tank 50 when the general-purpose engine unit 1 is overturned, with the control unit 30 facing downward. The same reference numerals as those described above denote the same or equivalent parts.

In the general-purpose engine unit 1 according to the present embodiment, the arrangement positions of the outlet member 15, the connection 54 to which the charge tube 6 is connected, and the drain pipe 53 to which the drain tube 51 is connected are set in addition to the shape and the capacity of the catch tank 50 so as to suppress the leakage of the stored fuel F to the outside of the catch tank 50 regardless of the direction in which the unit 1 is turned over. As a result, even when the catch tank 50 as a typical container is used instead of a canister, it is possible to make the catch tank 50 function well and reduce the cost.

The aspect of the general-purpose engine unit, the form of the engine, the shape and structure of the fuel tank and the air cleaner box, the length and routing method of the charge pipe and the charge tube, the shape and structure of the catch tank, the shape and structure of the rib, and so on are not limited to the above-described embodiment, and various modifications can be made.

### EXPLANATION OF REFERENCE NUMERALS

1…general-purpose engine unit, 2…fuel tank, 6…charge tube (fuel tube), 10…air cleaner box, 17…bottom wall of air cleaner box, 18…air inlet, 18a…intake direction line of air inlet, 18b…edge of air inlet, 50…catch tank, 52…rib, 54…connection, 55…wall part, E…engine, F…fuel

What is claimed is:

1. A general-purpose engine unit (1) configured by arranging a fuel tank (2) and an air cleaner box (10) in a horizontal direction above an engine (E), the general-purpose engine unit (1) comprising:
a catch tank (50) disposed in proximity to the air cleaner box (10) and configured to store evaporated fuel generated inside the fuel tank (2); and
a fuel tube (6) configured to send the evaporated fuel from the fuel tank (2) to the catch tank (50),
wherein the catch tank (50) is provided at a position above the engine (E) and between the fuel tank (2) and the air cleaner box (10).

2. The general-purpose engine unit according to claim 1,
wherein an air inlet (18) is provided at a lower part of the air cleaner box (10), and
wherein the catch tank (50) is disposed along an edge (18b) of the air inlet (18).

3. The general-purpose engine unit according to claim 2,
wherein the catch tank (50) is provided with a connection (54) to which one end part of the fuel tube (6) is connected,
wherein a rib (52) extending in a direction perpendicular to an intake direction line (18a) of the air inlet (18) is provided near the connection (54), and
wherein the intake direction line (18a) is disposed within a width of the rib (52) when viewed from a connecting direction of the fuel tube (6).

4. The general-purpose engine unit according to claim 3, wherein at least a part of the air inlet (18) is disposed within the width of the rib (52) when viewed in the direction perpendicular to the intake direction line (18a), and the rib (52) and the air inlet (18) overlap each other along the intake direction line (18a).

5. The general-purpose engine unit according to claim 2, wherein the catch tank (50) is configured such that a wall part (55) disposed along the edge (18b) is thicker than another wall part.

6. The general-purpose engine unit according to claim 3, wherein the catch tank (50) is directly attached to a bottom wall (17) of the air cleaner box (10).

7. The general-purpose engine unit according to claim 1, wherein the catch tank (50) is configured to have a negative pressure inside during operation of the engine (E).
